(19) United States
(12) Patent Application Publication
(10) Pub. No.: US 2008/0123792 A1
(43) Pub. Date: May 29, 2008

(54) Apparatus and method for transmitting signals over a signal line

(76) Inventors: Edoardo Prete, Dresden (DE); Hans-Peter Trost, Munich (DE); Anthony Sanders, Haar (DE); Dirk Scheideler, Munich (DE); Georg Braun, Holzkirchen (DE); Steve Wood, Munich (DE); Richard Johannes Luyken, Munich (DE)

Correspondence Address: SLATER & MATSIL LLP, 17950 PRESTON ROAD, SUITE 1000, DALLAS, TX, 75252, US

(21) Appl. No.: 11/604,649

(22) Filed: Nov. 27, 2006

(51) Int. Cl. H04L 7/04

(52) U.S. Cl. 375/362

(57) ABSTRACT

An apparatus for transmitting signals over a signal line includes a transmitter with an output connectable to the signal line, for a synchronization signal in a power saving mode and a wanted signal in a normal mode of operation, wherein the synchronization signal has a reduced amplitude as compared to an amplitude of the wanted signal and has a periodic data pattern so that the synchronization signal permits maintaining an alignment of the synchronization signal and a reference signal in the receiver.

### TECHNICAL FIELD

The present invention relates to an apparatus and a method for transmitting signals over a signal line, for example to an apparatus, applicable in the field of a transmitter or a transmitter circuit for a bus in a computer system, such as a memory system or a graphic system.

### BACKGROUND

In modern computer systems, data is transmitted over high speed buses, which are coupled on the sender side to a transmitter or a transmitter circuit and to a receiver or a receiver circuit on the receiver side of the bus. Both, a transmitter and a receiver can be coupled to an individual signal line, to a group of signal lines or to all signal lines of the bus. Depending on the concrete bus structure, in the case of a bi-directional bus, the respective signal lines can be coupled to both a transmitter and a receiver on both sides of the bus simultaneously, thereby enabling the same signal lines to be used for a data communication in both directions. However, modem bus structures often utilize different signal lines or sub-bus structures for a communication with respect to the two different directions. Hence, in these cases, each signal line is coupled on either side of the bus to either a receiver circuit or a transmitter circuit.

Most high-speed bus structures, however, usually require some sort of synchronization, a generation of common clock signals, a generation of aligned clock signals, or a recovery of a clock signal based on another clock signal or based on the signals transmitted over one or more signal lines. Such a recovery of a clock signal based on the signals transmitted over a signal line is usually referred to as CDR (Clock and Data Recovery).

An example of such a high speed computer bus, can for instance, be found in the field of modem memory systems, especially in the so-called FBDIMM architecture based on FBDIMMs (FBDIMM=Fully Buffered Dual Inline Memory Module).

However, an important challenge in modem computer technology and the development and design of new computer systems comes from the field of power consumption, which is in many cases a severely limiting factor. For instance, in the field of mobile computing, the available power is limited by the capacity of an accumulator or a battery, while in stationary systems the power consumption is often limited to temperature restrictions of the components involved. Hence, in many systems it is imperative to employ a power saving mode to reduce the power consumption.

Today's concept, for instance, for the high-speed interface in a FBDIMM system offers a power down mode, in which most of the power consuming circuits are shut off. However, the wake-up time after a restart of a circuit, which has been shut off, to get all parts back into an operative state, require the CDR as well as a data/frame alignment to be carried out, before data commands, status information and other signals can be reliably sent via the high-speed bus. Both the CDR and the data/frame alignment need a long time to settle, as first the control loop in the framework of the CDR has to settle, before the alignment procedure in the framework of the data/frame alignment can be started. In other words, first the control loop in the context of the CDR has to settle, followed by the alignment procedure, which has to wait for framed data to start its work.

### SUMMARY OF THE INVENTION

According to an embodiment of the present invention, an apparatus for transmitting signals over a signal line comprises a transmitter, comprising an output connectable to the signal line for a synchronization signal in a power saving mode and a wanted signal in a normal mode of operation, wherein the synchronization signal comprises a reduced amplitude as compared to an amplitude of the wanted signal and comprises a periodic data pattern so that the synchronization signal permits maintaining an alignment of the synchronization signal and a reference signal in a receiver.

According to a further embodiment of the present invention, an apparatus for transmitting signals over a signal line comprises a transmitter, comprising an output connectable to the signal line, for a synchronization signal in a power saving mode and a wanted signal with a transmission frequency in the normal mode of operation, wherein the synchronization signal comprises a reduced amplitude as compared to an amplitude of the wanted signal and comprises a non-zero frequency being lower than the transmission frequency.

According to a further embodiment of the present invention, a signal transmitter and receiver system comprises a signal line, a transmitter comprising an output coupled to the signal line, for a synchronization signal in the power saving mode and a wanted signal in a normal mode of operation and a receiver coupled to the signal line, wherein the synchronization signal comprises a reduced amplitude as compared to an amplitude of the wanted signal and comprises a periodic data pattern so that the synchronization signal permits maintaining an alignment of the synchronization signal and reference signal in the receiver.

### BRIEF DESCRIPTION OF THE DRAWINGS

Embodiments of the present invention are described hereinafter, making reference to the appended drawings.

FIG. 1 shows a block diagram of a first embodiment of an apparatus for transmitting signals over a signal line;

FIG. 2 shows an embodiment of a signal transmitter and receiver system, comprising an embodiment of an apparatus for transmitting signals over a signal line; and

FIGS. 3a to 3e show five examples of a periodic data pattern that permit maintaining an alignment of the synchronization signal with respect to an embodiment of an apparatus for transmitting signals and a reference signal.

### DETAILED DESCRIPTION OF ILLUSTRATIVE EMBODIMENTS

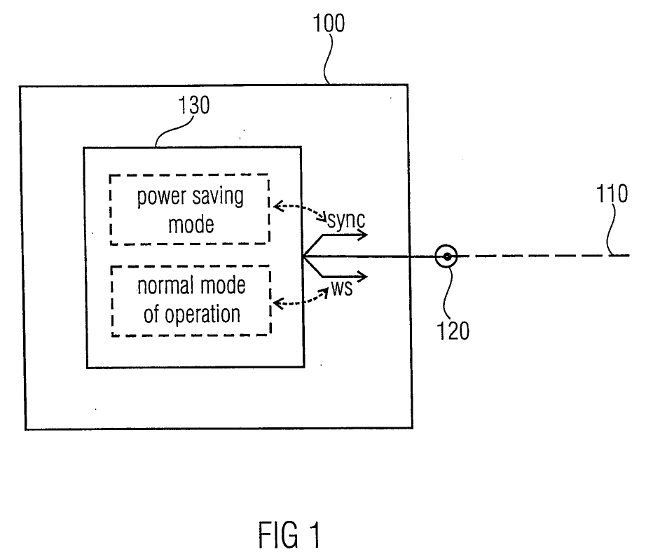

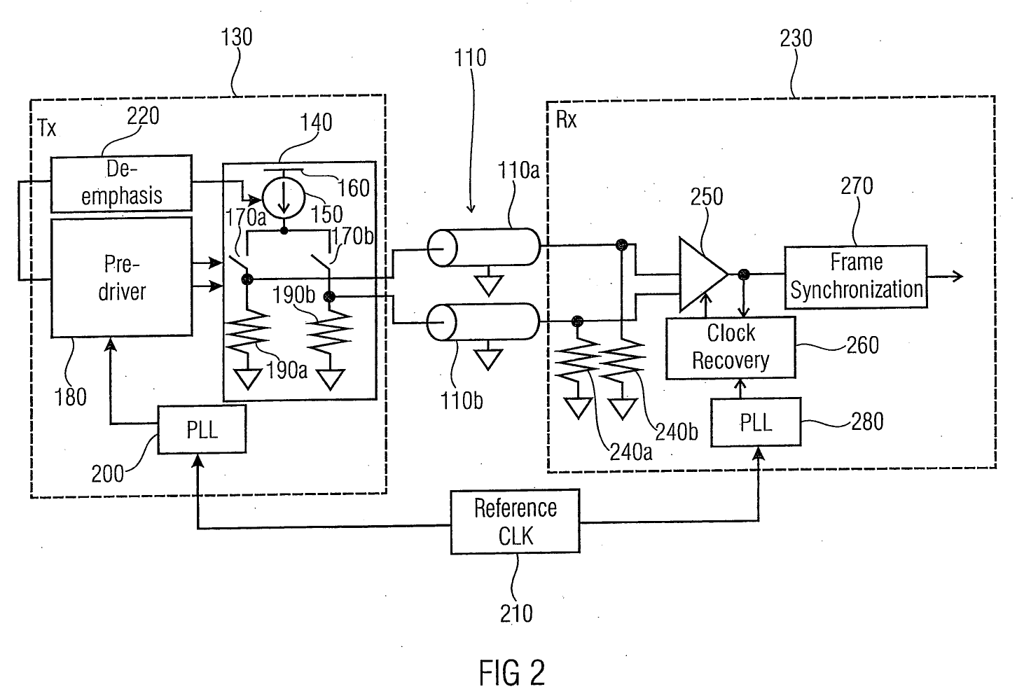

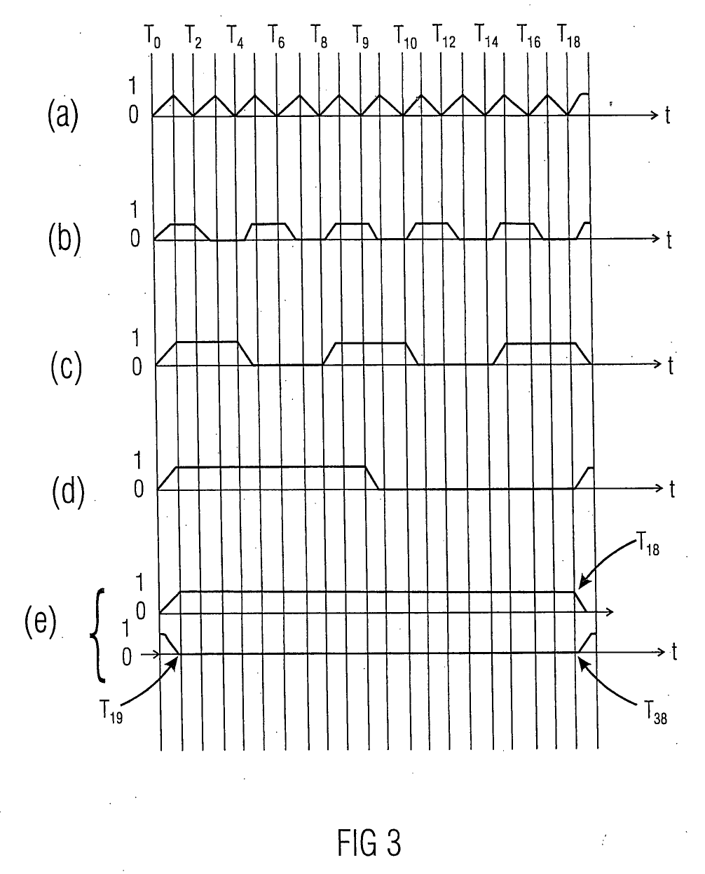

FIGS. 1 to 3e show block diagrams and examples of periodic data patterns according to the present invention. Before a second embodiment of the present invention is described with respect to FIG. 2 and FIGS. 3a to 3e, the first embodiment of an apparatus for transmitting signals over a signal line is explained with respect to the schematic representation of the block diagram shown in FIG. 1.

FIG. 1 shows a block diagram of a first embodiment of an apparatus 100 for transmitting signals over a signal line 110 connectable to a connector or a terminal 120 of the embodiment of the apparatus 100. The embodiment of the apparatus 100 comprises a transmitter or a transmitter circuit 130, which is coupled via an output of the transmitter 130 to the connector 120, so that the transmitter is connectable to the signal line 110. Depending on a mode of operation, the transmitter 130 provides different signals to the signal line 110, which is assumed to be coupled to the connector 120 and, hence, to the transmitter 130.

To be more precise, in a power saving mode, the transmitter 130 provides a synchronization signal, denoted as SYNC in FIG. 1 to the signal line 110, which comprises a reduced amplitude, as compared to an amplitude of a wanted signal output by the transmitter 130 in a normal mode of operation. The wanted signal is denoted in FIG. 1 as WS. The synchronization signal SYNC comprises a periodic data pattern so that the synchronization signal permits maintaining an alignment of the synchronization signal SYNC and a reference signal or a reference clock signal in a receiver not shown in FIG. 1.

As will be explained in more detail in the context of FIGS. 3a to 3e, the synchronization signal SYNC is based upon a transmission frequency of the wanted signal, but comprises a periodic data pattern which will be transmitted over the signal line with the reduced amplitude as compared to the amplitude of the wanted signal. The periodic data pattern comprises at least one transition between two different signal levels so that the synchronization signal SYNC due to the periodic nature of the data pattern comprises an effective frequency or a non-zero frequency, which is typically lower than the transmission frequency of the wanted signal in the normal mode of operation. As will be explained in more detail later, a repetition of a finite data pattern having at least one transition results in a synchronization signal comprising a periodic data pattern. In other words, the synchronization signal SYNC comprises a non-zero frequency, which is typically smaller than the transmission frequency of the wanted signal in the normal mode of operation, so that an AC component is present in the synchronization signal. Depending on the details and the concrete implementation as well as the environmental conditions, the non-zero frequency or the effective frequency of the synchronization signal SYNC is often the AC component (AC=Alternating Current), with a maximum amplitude in the frequency domain.

An advantage of an embodiment of the present invention in the form of an apparatus 100 for transmitting signals over the signal line is the fact that the transmitter 130 or the apparatus 100 consumes significantly less power in the power saving mode, which is mainly caused by the reduction of the amplitude of the synchronization signal SYNC compared to the wanted signal WS in the normal mode of operation. However, due to the fact that the synchronization signal SYNC is transmitted over the signal line 110, a receiver is capable of maintaining an alignment, or to be more accurate, a phase alignment with respect to the synchronization signal and a reference signal, which can for instance, be internally generated by the receiver or clock recovery, respectively, based on the periodic data pattern transmitted over the signal line 110, based on the effective frequency of the synchronization signal SYNC or on another reference signal.

As the damping of signals caused by the signal line 110 usually becomes larger with increasing frequency, a reduction of the effective frequency or the non-zero frequency of the synchronization signal SYNC also reduces the damping of the signal line so that a further reduction of the amplitude of a synchronization signal SYNC can be employed simply by reducing the effective frequency. In the normal mode of operation, a reduction of the transmission frequency is of course unwanted, as it reduces the available bandwidth of the bus or the signal line 110.

Furthermore, an advantage of an embodiment of the present invention is that the synchronization signal SYNC is not required to be transmitted error free or almost error free, as it does not comprise coded information or data. As the synchronization signal SYNC is only intended to provide a receiver, not shown on FIG. 1, with the ability to maintain the alignment or the phase alignment of the synchronization signal SYNC with respect to the reference signal of the receiver, the amplitude of the synchronization signal SYNC can be reduced even without reducing the effective frequency or the non-zero frequency of the synchronization signal SYNC itself, as long as a sufficient number of transitions of two different signal levels are recognized by the receiver, not shown in FIG. 1, which are transmitted over the signal line 110 in the power saving mode.

Depending on the concrete implementations as well as the environmental conditions, a reduced amplitude, of the synchronization signal SYNC of less than or equal to 0.35 of the amplitude of the wanted signal WS and/or a non-zero or effective frequency of the synchronization signal SYNC lower than or equal to 0.1 of the transmission frequency of the wanted signal WS, offers a substantial power saving capability and can be realized. In some embodiments the reduced amplitude of the synchronization signal SYNC is approximately ⅓ of the amplitude of the wanted signal WS. In some embodiments a reduction of the amplitude of the synchronization signal SYNC to a value of 0.2 or less of the amplitude of the wanted signal WS can be implemented. Even a further reduction of the amplitude of the synchronization signal with an embodiment of an apparatus with an appropriate receiver operating with an amplitude of the synchronization signal SYNC of less than or equal to ⅙ of the amplitude of the wanted signal WS can be utilized to increase the power saving capabilities. Such embodiments of the present invention have been operated with an effective or non-zero frequency of the synchronization signal SYNC of less than or equal to 0.05 of the transmission signal of the wanted signal WS in the normal mode of operation.

Hence, embodiments of the present invention are based on the findings that due to the possibility of maintaining a phase alignment of the synchronization signal SYNC and the reference signal in a receiver, a long wake-up time can be avoided by ensuring an alignment of the phases mentioned and, at the same time, reducing the power consumption by employing a reduction of the signal amplitude of the transmitter 130, and by transmitting a (periodic) data stream or pattern optimized for the receiver allowing a recovery by the CDR. As indicated earlier, the transmitted data patterns or transmitted data streams optimized for the clock and data recovery will be explained in more detail in the context of FIG. 3a to 3e. As a consequence, an embodiment of an apparatus 100 for transmitting signals over a signal line 110 offers the advantage over a possible solution of a memory system offering only a simple power down mode, in which most of the power consuming circuits are shut out, that the wake-up time needed to get all parts into an operative state again is dramatically reduced, and thereby offer circumventing the disadvantage of the possible solution outlined above.

Before describing the second embodiment of the present invention in more detail, it should be noted that objects, structures, signals and components with the same or similar functional properties or features are denoted with the same reference signs. Unless explicitly noted otherwise, the description with respect to objects, structures, signals, and components with similar or equal functional properties can be exchanged with respect to each other.

FIG. 2 shows an embodiment of a signal transmitter and receiver system comprising a transmitter or a transmitter circuit 130 coupled to a signal line 110. The signal line 110 is in the embodiment shown in FIG. 2, a differential signal line 110, comprising a first differential signal line 110a and a second differential signal line 110b. Both differential signal lines 110a and 110b furthermore comprise an electrostatic shielding, which is coupled to a reference potential (cf. ground potential, GND) as indicated by the triangles shown in FIG. 2. In the case of a memory system according to the FBDIMM architecture, the signal line 110 can be one of the 10 or 14 signal lines of the memory bus depending on the direction of the communication.

The transmitter 130 comprises a differential driver 140, which is directly connected to the signal line 110, or to be more precise, to the two differential signal lines 110a, 110b. The differential driver 140 comprises a controllable current source 150, which can for instance, be implemented as a band gap based current source with parallel programmable current mirrors, providing a (constant) current so that depending on a control signal, the current provided by the current source 150 can be controlled or adjusted based on the control signal by switching one or more transistors into the effective circuitry of the current source 150. However, other implementations of a controllable current source 250 can be used, which can, for instance, be based on a current emitter, an operational amplifier or a transistor circuit.

The differential driver 140 is, however, a CML style driver (CML=Current Mode Logic), which is sometimes also referred to as an ECL style driver (ECL=Emitter Coupled Logic). A chief characteristic of a CML style driver is that the transmitters involved are always in an active region of their characteristic, and can thus change its state very rapidly, allowing CML circuits to operate at a very high speed. In other words, a CML style driver as well as the CML logic family operates on the basis of currents being steered through transistors to compute logical functions or to create signals. Although CML style driver technology creates, especially compared to the CMOS technology (CMOS=Complementary Metal Oxide Semi-conductor) in a stationary state, a large current requirement, while in a dynamic state a CML style driver topology may offer an approximately constant current requirement, which does not depend significantly on the actual state of the circuit itself.

This means that the CML style driver circuit generates relatively little power noise, unlike many other logic or driver types, which typically draw far more current when switching then quiescent, which can especially become problematic in the field of a high speed signal transmission via a high speed signal line of a high speed bus. Furthermore, CML style drivers can operate in less than a nanosecond, offering very high transmission frequencies for wanted signals in a normal mode of operation. Hence, CML style drivers offer very high performance.

The current source 150 is connected with one terminal to a positive power supply voltage 160 and with a second terminal to two transistors 170a and 170b in a parallel configuration, which are shown in FIG. 2 as two switches. Depending on the concrete implementation of an embodiment of the differential driver 140, the transistors 170a and 170b can be implemented as switches or controllable resistors, wherein the resistances of the resistors depends on control signals, provided by a predriver 180 of the transmitter 130. However, if the transistors 170a and 170b are implemented, as bi-polar transistors, the predriver 180 is connected to the basis terminals of the two transistors and to the gate terminals of the two transistors, if the two transistor terminals 170a and 170b are implemented as field effects transistors (e.g. NMOS transistors—NMOS=N-Metal Oxide semiconductor Transistors).

The two transistors 170a and 170b are furthermore each connected via resistors 190a and 190b with the reference potential or the ground potential (GND), indicated by triangles in FIG. 2. Depending on the concrete implementation, the two resistors 190a and 190b can be implemented as 50Ω resistors. A terminal of each of the resistors 190a and 190b is furthermore connected to the two differential signal lines 110a and 110b respectively.

Apart from the control signals for the two transistors 170a and 170b, the predriver 180 also comprises an input for an input signal indicating the data to be transmitted. Furthermore, the predriver 180 also comprises an input for a clock signal which is provided by a phase lock loop circuit 200 (PLL), which provides the predriver 180 with the clock signal based on a reference clock signal from an external reference clock 210 (reference CLK) which is typically not comprised in the transmitter 130. The reference clock 210 can, for instance, be implemented as a part of a bus in a memory system or as another clock signal source. The transmitter is denoted in FIG. 2 as “Tx”. In the same embodiments, the phase lock loop circuit or PLL 200 provides the predriver 180 with a clock signal, which is an upsampled clock signal based on the reference clock signal, provided by the reference clock 210. Typically, the frequency of the clock signal provided by the PLL 200 comprises a frequency, which is ten times or more, higher than the frequency of the reference clock 210. A typical value for a concrete implementation can, for instance, be a frequency of the PLL 200 being 24 times higher than the frequency of the reference clock 210.

As mentioned before, the predriver 180 furthermore comprises an input to which the signals to be transmitted over the signal line 110 in the normal mode of operation are provided. However, the input signal is not only provided to the predriver 180, but also to a de-emphasizer 220, which is connected to the control of the current source 150, to provide the current source 150 with the control signal indicative of the current to be output by the current source 150.

FIG. 2 furthermore shows a receiver 230, which is marked in FIG. 2 as “Rx”. The receiver 230 comprises two resistors 240a and 240b, which are connected to the signal lines 110a and 110b, respectively. Typically, the two resistors 240a and 240b comprise resistances equivalent to the two resistors 190a and 190b of the transmitter 130. With a second terminal, each of the two resistors 240a and 240b is connected to the reference potential or ground potential (GND) as indicated by the triangles in FIG. 2.

The receiver 230 furthermore comprises a differential amplifier 250, which is connected to the two differential signal lines 110a and 110b. Furthermore, the differential amplifier 250 is connected to a clock recovery circuit 260 providing the differential amplifier 250 with a clock signal. Moreover, the differential amplifier 250 comprises an output, which is connected to a clock recovery circuit 260 and to a frame synchronization block or circuit 270, which will be explained in more detail later.

The reference clock 210, which is also usually not comprised in the receiver 230, is connected to a phase lock loop circuit or PLL 280 of the receiver 230, which in turn is connected to the clock recovery circuit 260. As explained in the context of the PLL 200 of the transmitter 130, the reference clock 210 provides the PLL 280 with a reference clock signal, which is upsampled by the PLL 280 and output as an upsampled clock signal to the clock recovery circuit 260.

As indicated earlier, the embodiment of the signal transmitter receiver system shown in FIG. 2 is based on a CML style driver topology. Depending on the concrete implementation, a typical differential driver 140, in the case of a CML style driver, transmits data in a differential way over two distinctive differential signal lines 110a and 110b. Usually, an LVDS transmission scheme is employed (LVDS=Low Voltage Differential Signaling) with its benefits resulting from the differential transmission.

As a consequence, the receiver 230 employs the differential amplifier 250 to create a single ended signal out of the differential signal transmitted over the signal line 110 as an input stage. The differential amplifier 250 furthermore comprises a sample-and-hold stage, triggered by the clock recover circuit 260 resulting in an output signal of the differential amplifier 250, which is indicative of the difference between the signal levels provided by a transmitter 130 over the two differential signal lines 110a and 110b. A clock signal provided by the clock recovery circuit 260 to the differential amplifier 250, which are used by the differential amplifier 250 for creating the single ended signal determine the moments in time.

The clock recover circuit 260 is a part of a closed loop control circuit which is capable of phase shifting the clock signal received from the PLL 280 to create the clock signal for the differential amplifier 250 in response to the signal level output at its input. In other words, the clock recovery circuit 260 is a closed feedback loop, which adapts the phase of the clock signal provided to the differential amplifier 250, based on the clock signal from the PLL 280 in accordance with the input of the sample-and-hold stage as part of the differential amplifier 250. Hence, a clock recovery circuit 260 usually comprises at least a phase shifting circuit, which is capable of shifting the phase of the clock signal received from the PLL 280 before providing the shifted clock signal to the differential amplifier 250. As a basis, the clock recovery circuit 260 is also connected to the differential amplifier 250 so that the clock recovery circuit 260 is capable of measuring, for instance, the bit error rate. As one possibility, the clock recovery circuit 260 is then capable of minimizing the error rate output by the differential amplifier 250, which leads to a sampling of the incoming signal over the signal line 110 in such a way that the internal clock signal or (internal) reference signal provided by the PLL 280 on the basis of the reference clock signals by the reference clock 210, is in the “eyes” of the data transmitted.

The frame synchronization block 270 is a circuit, which provides further signal shaping and signal processing capabilities, which are required in the framework of the further signal processing. To be more precise, the frame synchronization block 270 is usually not only connected to the differential amplifier 250 of the signal line 110, but also to the outputs of respective differential amplifiers for other signal lines comprised in the bus of which the signal line 110 is one signal line.

In other words, the frame synchronization block 270 takes care of further signal shaping and signal pre-processing required for the further signal processing. As a consequence, the frame synchronization block 270 often comprises a deskew block, which introduces additional delays to the signals provided to the frame synchronization block 270 to compensate phase shift between signals received via different signal lines, due to different delays caused by different signal processing circuits and delays caused by different lengths of the signal lines. In a memory system according to the FBDIMM architecture, the memory bus comprises 10 differential signal lines (i.e., 10 differential signal line pairs) for one direction of the signal transportation and 14 differential signal lines in the opposite direction. The deskew circuit comprised in the frame synchronization block 270 compensates phase differences of the incoming signal as provided by differential amplifiers. Furthermore, the frame synchronization block 270 comprises a circuit for decoding, for downsampling and for further digital adjustments, which are required in the further processing of the signals received via the signal lines. In other words, while the deskew block comprised in the frame synchronization block 270 aligns different signals on a signal level, further blocks comprised in the frame synchronization block 270 will decode the signals, for instance, by employing a de-multiplexer and down sampling the signals as required by the further circuits.

Switching back to the transmitter 130, depending on the concrete implementation of an embodiment of the apparatus for transmitting a signal over the signal line, the transistors 170a and 170b of the differential driver 140 can either be switched on or off, or can be switched between different resistance levels so that either a full swing signal or a reduced swing signal is provided to the two differential signal lines 110a and 110b to be transmitted over to the receiver 130. However, as in the embodiment shown in FIG. 2, the signal transmission is done by a differential signal transmission, the two transistors 170a and 170b are controlled by the predriver 180 in such a way that, for instance, the duty-cycle at the output of the transmitter is 50% by means of adjusting the amplitude of the predriver 180. In other words, if the predriver 180 opens, for instance, transistor 170a slightly or completely, the second transistor 170b will be closed accordingly, so that the current provided by the current source 150 is merely redistributed over the two branches of the parallel circuit of the differential driver 140.

As a consequence, the voltage level of the two differential signal lines 110a and 110b will be changed accordingly. Hence, the CML style driver topology of the differential driver 140 can be used for transmitting either full swing signals or reduced swing signals, depending on the concrete implementation.

In a normal mode of operation, the data to be transmitted is provided to the predriver 180, which encodes the data to be transmitted into control signals for the two transistors 170a and 170b and thereby encodes the signals to be transferred over the signal line 110 into different voltage levels transmitted to receiver 230. During the predriver 180 providing the two transistors 170a and 170b with varying control signals, the de-emphasizer 220 provides the current source with a control signal so that the amplitude of the wanted signal reaches its nominal value.

However, when the transmitter 130 is switched into the power saving mode, which can, for instance, be done by transmitting a special pattern to the predriver 180 and to the de-emphasizer 220 via their inputs or, alternatively or additionally, by providing a special signal to the transmitter 130, a de-emphasizer 220 drastically reduces the current provided by the current source 150 by adapting the control signal for the current source 150 accordingly.

Hence, the voltage levels provided to the signal lines drop and the amplitude of the synchronization signal will be reduced accordingly, as explained in the context of the embodiment shown in FIG. 1. Furthermore, the synchronization signal provided by the transmitter 130 to the signal line 110, comprises a periodic data pattern, which can either be created by the predriver 180 or can be provided to the predriver 180 via its input, depending on the concrete implementation of the embodiment. However, the predriver 180 adjusts the control signals for the two transistors 170a and 170b accordingly, so that the synchronization signal is provided to the signal line 110 and to the receiver 230 with the reduced amplitude of the synchronization signal, as compared to the amplitude of the wanted signal in the normal mode of operation.

In other words, as the dominating circuit in terms of power consumption is the output driver of the differential driver 140, and as in a CML style driver topology, as shown in FIG. 2, the power consumption is approximately linearly related to the signal amplitude bus, a power saving mode, which still allows maintaining an alignment or a phase alignment of the synchronization signal output by the transmitter 130 and a reference signal, for instance the clock signal provided by the PLL 280 in the receiver 230 allows a significant energy savings. Compared to a possible solution of a power saving mode in which all power consuming or most of the power consuming circuits are turned off, a smaller wake-up time can be realized by employing an embodiment of an apparatus or transmitting signals over a signal line, as the PLL 280 and/or the clock recovery circuit 260 can maintain the phase alignment so that the need to wait for resettling of the PLL 280 and the clock recovery circuit 160 is overcome.

Since in the power down mode or power saving mode there is no need to receive error-free data and a higher bit error rate can be tolerated, the amplitude of the synchronization signal may be reduced to a level allowing the CDR in the form of a clock recovery circuit 160 and the PLL 280 to work without losing lock, and therefore, maintaining the alignment of the incoming synchronization signal with the reference signal provided by the PLL 280. In other words, during the power saving mode the PLL 200 and the PLL 280 will not be shut down, but will remain activated to maintain the phase alignment and to enable the clock recovery even during the power saving mode. Hence, an embodiment of the present invention prohibits a loss of the alignment and yet enables a reduction of the power consumption.

However, to enable a clock data recovery during the power saving mode, the data pattern transmitted in the framework of the synchronization signal comprises a special data stream, comprising at least one transition between two signal levels, for instance, in the case of a binary or digital signal by transition between 0 and 1, so that the synchronization signal is a periodic signal due to a periodic repetition of the periodic data pattern resulting in a periodicity of the data pattern transmitted. The periodic data pattern or the special data stream can, for instance, comprise a clock-like pattern that allows a further reduction of the amplitude of the synchronization signal transmitted over the signal line 110 due to the high number of transitions of such a data pattern. Furthermore, the signal requirements posed by the receiver 230 in the framework of the clock data recovery allow a reduction of the amplitude of the synchronization signal, as the requirements in terms of the inter-symbol interference (ISI) can also be relaxed.

As previously mentioned, usually the damping of the signal line increases with the increasing frequency of the transmitted signals, the reduction of the synchronization signal furthermore allows an additional reduction of the amplitude, and hence, an additional reduction of the power consumption.

Before discussing typical data patterns, amplitudes and frequencies in the framework of FIG. 3a to FIG. 3e, it should be noted that an embodiment of the present invention is not limited to either a single ended signal transmission via a single ended transmission line, nor to a differential transmission line by differential path signal links or a differential signal line. Furthermore, the embodiments of the present invention are not limited to full swing signals or reducing signals. Furthermore, embodiments can be employed in the framework of both binary or digital signal transmissions and in the field of multi-level or discreet signal transmissions.

Before periodic data patterns are discussed, which can be transmitted over a signal line 110, and which are optimized for the receiver 230 and for the clock recovery 260 with a reduced output amplitude of the synchronization signal, which allows to keep the phase locked and at the same time save power, it should be noted that depending on the concrete implementation of an embodiment, the amplitude of the transmitter in the power saving mode can, for instance, be pre-determined and set to a fixed value, which can, for instance, be hardwired or programmed to the transmitter 130 in a non-changeable way. On the other hand, the amplitude can also be adaptable or programmable so that the amplitude of the synchronization signal can be altered by an external signal or be altered by an external signal or be altered, for instance, depending on the data pattern to be transmitted. In a further embodiment of the present invention, a feedback loop can be established for providing the transmitter 130 with information concerning the ability of the receiver 230 to maintain the phase alignment. This can, for instance, be done by a further transmitter transmitting signals back to the component comprising an embodiment of the apparatus or by a further interface, which can for instance be operated at a significantly lower frequency than the frequencies used in the framework of the signal lines 110. Moreover, such a feedback signal is not required to be present all the time.

As embodiments of an apparatus for transmitting signals over a signal line enables a method to reduce wake-up time and enabling a low power consumption by ensuring a phase relationship by transmitting a pattern with a lower amplitude, embodiments of the present invention can for instance be employed in the field of memory buffers, especially advanced memory buffers in the case of daisy chained systems, like AMB2 or AMB3, in the case of fully buffered DIMM (DIMM=Dual Inline Memory Module). In the following, especially periodic data patterns will be described, which can be implemented in the framework of a memory buffer, especially for FBDIMMs.

FIGS. 3a to 3e show five different data patterns, which can be transmitted as a periodic data pattern in the power saving mode, based on how the synchronization signal is output by the transmitter 130. To be more precise, FIGS. 3a to 3e show five data patterns or signals as a function of time t. In this context, the abscissa indicating that time t is divided by vertical lines labeled T₀ to T₁₉, which indicate moments of time, with respect to the transmission frequency of the wanted signal in the normal mode of operations. In other words, the difference with respect to the lapsed time of two consecutive vertical lines (e.g., T₅ and T₄) is equal to the period of the transmission frequency of the wanted signal in the normal mode of operation. In the case of a FBDIMM memory system based on DDR memory devices (DDR=Double Data Rate), a transmission frequency or so called baud rate in the range of approximately 4.8 Gbit/s is typical. In this case, the difference of time between two different vertical lines in FIG. 3 is in the range of approximately 200 picoseconds (200 ps).

The synchronization signal provided by the transmitter 130 in the power saving mode is based on the transmission frequency and the periodic data pattern, of which of course, only one period has to be specified. In this context, the term “periodic data pattern” also refers to only a single period of the data pattern.

FIG. 3a shows as a first data pattern, the data pattern {01} which is repeated. Due to the fact that the data pattern comprises two values, or to be more precise, as the smallest period of the data pattern comprises two values, the effective frequency or the non-zero frequency of the synchronization signal is half the frequency of the transmission frequency fₜ. In other words, in the example above, the frequency of the synchronization signal f_{sync} is in the range of approximately 2.4 GHz.

In this context, it should be noted that in FIG. 3 as well as in the description of the data patterns above and below, the amplitude of the synchronization signal is not taken into account. The question of the amplitudes of the synchronization signal will be addressed shortly.

FIG. 3b shows a second possible data pattern, comprising at the shortest period the pattern {0110} so that the frequency in this case is a quarter of the transmission frequency {f_{sync}=0.25·fₜ}. Accordingly, the data pattern shown in FIG. 3c comprises the values {01111000} which results in a non-zero frequency at the synchronization signal or an effective frequency of the synchronization signal of ⅛ of a transmission frequency f_{sync}=0.125·fₜ}. FIG. 3d shows as a fourth example of a periodic data pattern, the data pattern {0111111110000000} so that the non-zero frequency of a synchronization signal is 1/16 of the transmission frequency {f_{sync}=fₜ/16}. Accordingly, FIG. 3e shows as a fifth example on the periodic data pattern, a data pattern that comprises 32 values, which are evenly distributed between 0 and 1 with blocks of 16 0s and 16 1s, respectively. In FIG. 3e, the first line is continued according to the time marks in the time marks in the second line of FIG. 3e. Accordingly, the frequency of the synchronization signal is in this case f_{sync}=fₜ/32}.

In principle, any other data pattern can be used as a basic period for the periodic data pattern. However, in this context it is important that the data pattern at least comprise one transition between the two different data values or signal levels so that the synchronization signal is a periodic, non-constant signal comprising a non-zero frequency or effective frequency. In other words, it is important that the synchronization signal comprises an AC component so that at least one transition occurs regularly to enable the clock data recovery to maintain the phase alignment or the alignment of the synchronization signal to an internal reference signal.

In principle, the data pattern is not required to comprise an equal number of the possible signal levels, as it was shown in FIG. 3a to 3e. In principle, a different ratio of the different signal levels can be implemented in the framework of the periodic data pattern. As an example, the periodic data pattern, or rather the shortest period of the data pattern given by {0001} represents a possible synchronization signal with a frequency of 0.25 of the transmission frequency of the wanted signal in the normal mode of operation. However, in this data pattern, the different signal levels are not evenly distributed.

Furthermore, it should be noted that the signal transmitted over the signal line with the transmission frequency fₜ has approximately a sinusoidal shape, as an average edge rising time equals roughly half the period associated with the transmission frequency. Hence, at lower frequencies or lower effective frequencies, the signal shape becomes more and more different from pure sinusoidal signals. As a consequence, the frequency distribution will show more and more contributions at high frequencies. Hence, it should be noted that the transmission frequency as well as the effective frequency or the non-zero frequency of the synchronization signal is defined with respect to the lowest intended frequency. Very often this frequency comprises the highest amplitude in the frequency domain or in the frequency representation of the signal.

As indicated earlier, to profit from the decreasing dampening of the signal lines with decreasing frequencies, a data pattern with an evenly distributed number of 0s and 1s arranged in blocks in the case of a binary or digital signal, resulting in an effective frequency or non-zero frequency of the synchronization signal of less than or equal to 0.1 of the transmission frequency is typically chosen. In other words, in the case of a FBDIMM system, as outlined above, typically the synchronization signal comprises a frequency of about 0.48 GHz. In some embodiments, by reducing the effective frequency of the non-zero frequency further, an additional reduction of the amplitude can be achieved. In other words, in some embodiments an effective frequency or the non-zero frequency of the synchronization signal of 0.05 of the transmission frequency will be implemented as this offers a significant reduction of the amplitude, while still providing a sufficient number of transitions between 0s and 1s, which allows maintaining an alignment of the synchronization signal and a reference signal in a receiver.

Using an evenly distributed periodic data pattern in this context is especially favorable as in this case the synchronization signal does not comprise significant contributions at higher frequencies, which will be damped by the signal line more significantly. Hence, a signal based on a data pattern, as outlined above, can reduce the amplitude more clearly. Furthermore, it should be noted that although the examples of periodic data patterns mentioned above are based on ratios based on the transmission frequency and the effective frequency of the synchronization signal of the form 2n, wherein n is a positive integer, in principle any integer ratio can be employed. An example of such a data pattern can for instance be {0000011111} which leads to an effective frequency of the synchronization signal of 0.1 of the transmission frequency (f_{sync}=fₜ/10). Accordingly, the periodic data pattern comprising {000000001111111111} results in an effective frequency of the synchronization signal of 0.05 of the transmission frequency (f_{sync}=fₜ/20).

With respect to the amplitudes, employing a frequency of the synchronization signal of 0.05 of the transmission frequency or below enables a reduction of the amplitude of the synchronization signal compared to the amplitude of the wanted signal in the normal mode of operation typically to less than ⅓ of the amplitude of the wanted signal in the normal mode of operation. To be more precise, typically the amplitude of the synchronization signal can be reduced to 0.35 of the amplitude of the wanted signal in the normal mode of operation. However, especially if the non-zero frequency or the effective frequency of the synchronization signal is in the range of 0.05 of the transmission frequency, or below the amplitude of the synchronization signal can be reduced to less than 0.2 of the amplitude of the wanted signal in the normal mode of operation. Typical values comprise 0.17, 0.15, 0.12 and 0.1 for the ratio of the two aforementioned amplitudes.

In the case of a FBDIMM as explained above, an embodiment of an apparatus for transmitting signals over a signal line comprises the amplitude for the wanted signal in the normal mode of operation, a peak-to-peak voltage of roughly 900 mV. By reducing the frequency of the synchronization signal to 0.1 of the transmission frequency, i.e., from 4.8 GHz to 0.48 GHz, the amplitude of a synchronization signal can be reduced to values of roughly 300 mV or below. In other words, the amplitude of the synchronization signal can be reduced by a factor of 3 compared to the amplitude of the wanted signal. By reducing the frequency even further, an amplitude of a synchronization signal of roughly 150 mV compared to 900 mV, in the case of a wanted signal in the normal mode of operation, can be realized. The reduction by a factor of 6 of the amplitude of the synchronization signal compared to the amplitude of the wanted signal can, for instance, be achieved by lowering the frequency of the synchronization signal or the effective frequency of a synchronization signal to 0.05 of the transmission frequency.

Furthermore, it should be noted that maintaining an alignment of the synchronization signal and a reference signal is achieved, if the alignment between the two signals is achieved within a specified margin of less than ±0.25 of a period of the synchronization signal, or in a more preferred embodiment, if the alignment can be maintained within a specified margin of less than ±0.1 of a period of the synchronization signal. In this context, it should be further noted that the synchronization signal and the reference signal are not required to have identical frequencies. In principle, any positive rational ratio between the frequencies of the synchronization signal and of the reference signal in the receiver can be utilized to maintain the alignment. However, an integer ratio of the two signals provides an easier clock and data recovery and an easier alignment of the two signals.

Moreover, in the context of the present application, two components are coupled to each other, if they are being directly connected to each other or via a further component.

Depending on certain implementation requirements of embodiments of the inventive methods, embodiments of the inventive methods can be implemented in hardware or in software. The implementation can be performed using a digital storage medium, in particular, a disc, a CD or a DVD having an electronically readable control signal stored thereon, which cooperates with the programmable computer system, processor or an integrated circuit, such that an embodiment of the present inventive method is performed. Generally, an embodiment of the present invention is, therefore, a computer program product with a program code stored on the machine-readable carrier or storage medium, the program code being operative for performing an embodiment of the inventive methods, when the computer program product runs on the computer, the processor or the integrated circuit. In other words, embodiments of the inventive methods are, therefore, a computer program having a program code for performing at least one of the embodiments of the inventive methods, when the computer program runs on a computer, a processor or an integrated circuit.

While the foregoing has been particularly shown and described with reference to particular embodiments thereof, it should be understood by those skilled in the art that various other changes in the form and details may be made without departing from the spirit and scope thereof. It is to be understood that various changes may be made in adapting to different embodiments without departing from the broader concept disclosed herein and comprehended by the claims that follow.

What is claimed is:

1. An apparatus for transmitting signals over a signal line, the apparatus comprising:
a transmitter comprising an output connectable to the signal line, the output for carrying a synchronization signal in a power saving mode and a wanted signal in a normal mode of operation,
wherein the synchronization signal comprises a reduced amplitude as compared to an amplitude of the wanted signal and comprises a periodic data pattern so that the synchronization signal permits maintaining an alignment of the synchronization signal and a reference signal in a receiver to be maintained.

2. The apparatus according to claim 1, wherein the synchronization signal permits a phase alignment of the synchronization signal with respect to the reference signal in the receiver to be maintained.

3. The apparatus according to claim 2, wherein the synchronization signal permits the alignment within a specified margin of less than ±0.25 of a period of the synchronization signal to be maintained.

4. The apparatus according to claim 1, wherein the data pattern comprises at least one transition between two different signal levels.

5. The apparatus according to claim 1, wherein the amplitude of the synchronization signal is less than or equal to 0.35 of the amplitude of the wanted signal.

6. The apparatus according to claim 1, wherein the synchronization signal comprises an effective frequency based on the periodic data pattern and a transmission frequency of the wanted signal in the normal mode of operation.

7. The apparatus according to claim 6, wherein the effective frequency of the synchronization signal is less than or equal to 0.1 of the transmission frequency of the wanted signal.

8. The apparatus according to claim 1, wherein the signal line comprises a differential transmission signal line.

9. The apparatus according to claim 1, wherein the transmitter is switchable to the power saving mode by a first signal at an input coupled to the signal line or a further signal line.

10. The apparatus according to claim 1, further comprising a controller with an output for a second signal connectable to the signal line or a further signal line, wherein the second signal instructs a switching to the power saving mode.

11. An apparatus for transmitting signals over a signal line, the apparatus comprising:
a transmitter comprising an output connectable to the signal line, for a synchronization signal in a power saving mode and a wanted signal with a transmission frequency in a normal mode of operation,
wherein the synchronization signal comprises a reduced amplitude as compared to an amplitude of the wanted signal and comprises a non-zero frequency being lower than the transmission frequency.

12. The apparatus according to claim 11, wherein the non-zero frequency of the synchronization signal is lower than or equal to 0.1 of the transmission frequency.

13. The apparatus according to claim 11, wherein the synchronization signal permits maintaining a phase alignment of the synchronization signal and a reference signal in a receiver.

14. The apparatus according to claim 13, wherein the synchronization signal permits maintaining the phase alignment within a specified margin of less than ±0.25 of a period of the synchronization signal.

15. The apparatus according to claim 11, wherein the synchronization signal is based on the transmission frequency and a periodic data pattern comprising at least one transition between two different signal levels.

16. The apparatus according to claim 11, wherein the amplitude of the synchronization signal is less than or equal to 0.35 of the amplitude of the wanted signal.

17. The apparatus according to claim 11, wherein the signal line comprises two signal lines for transmitting signals differentially.

18. An apparatus for transmitting signals over a signal line, the apparatus comprising:
means for outputting a synchronization signal in a power saving mode to the signal line and for outputting a wanted signal in a normal mode of operation to the signal line,
wherein the synchronization signal comprises a reduced amplitude as compared to an amplitude of the wanted signal and comprises a periodic data pattern so that the synchronization signal permits maintaining an alignment of the synchronization signal and a reference signal in a receiver.

19. The apparatus according to claim 18, wherein the synchronization signal permits maintaining a phase alignment as the alignment within a specified margin of less than ±0.25 of a period of the synchronization signal.

20. The apparatus according to claim 18, wherein the amplitude of the synchronization signal is equal to or less than 0.35 of the amplitude of the wanted signal.

21. The apparatus according to claim 18, wherein the synchronization signal comprises an effective frequency based on a transmission frequency of the wanted signal and the periodic data pattern such that the effective frequency is equal to or less than 0.1 of the transmission frequency.

22. A method for transmitting signals over a signal line, the method comprising:
outputting a synchronization signal to the signal line in a power saving mode and outputting a wanted signal in a normal mode of operation to the signal line,
wherein the synchronization signal comprises a reduced amplitude as compared to an amplitude of the wanted signal and comprises a periodic data pattern so that the synchronization signal permits maintaining an alignment of the synchronization signal and a reference signal.

23. The method according to claim 22, wherein the synchronization signal permits maintaining a phase alignment within the specified margin of less than ±0.25 of a period of the synchronization signal.

24. The method according to claim 22, wherein the periodic data pattern comprises at least one transition between two different signal levels.

25. The method according to claim 22, wherein the synchronization signal comprises an effective frequency based on a transmission frequency of the wanted signal and the data pattern such that the effective frequency is less than or equal to 0.1 of the transmission frequency.

26. A method for transmitting signals over a signal line, the method comprising:
outputting a synchronization signal in a power saving mode to the signal line and outputting a wanted signal with a transmission frequency in a normal mode of operation to the signal line,
wherein the synchronization signal comprises a reduced amplitude as compared to an amplitude of the wanted signal and comprises a non-zero frequency being lower than the transmission frequency.

27. The method according to claim 26, wherein the non-zero frequency of the synchronization signal is lower than or equal to 0.1 of the transmission frequency.

28. The method according to claim 26, wherein the synchronization signal permits maintaining a phase alignment of the synchronization signal and a reference signal within a specified margin less than ±0.25 of a period of a synchronization signal.

29. The method according to claim 26, wherein the synchronization signal is based on a periodic data pattern comprising at least one transition between two different signal levels.

30. The method according to claim 26, wherein the amplitude of the synchronization signal is lower than or equal to 0.35 of the amplitude of the wanted signal.

31. A computer program for performing, when running on a computer, a method for transmitting signals over a signal line, the method comprising:
outputting a synchronization signal to the signal line in a power saving mode and outputting a wanted signal in a normal mode of operation to the signal line,
wherein the synchronization signal comprises a reduced amplitude as compared to an amplitude of the wanted signal and comprises a periodic data pattern so that the synchronization signal permits maintaining an alignment of the synchronization signal and a reference signal.

32. A computer program for performing, when running on a computer, a method for transmitting signals over a signal line, the method comprising:
outputting a synchronization signal in a power saving mode to the signal line and outputting a wanted signal with the transmission frequency in a normal mode of operation to the signal line;
wherein the synchronization signal comprises a reduced amplitude as compared to an amplitude of the wanted signal and comprises a non-zero frequency being lower than 0.1 of the transmission frequency.

33. A signal transmitter and receiver system, comprising:
a signal line;
a transmitter comprising an output coupled to the signal line, for a synchronization signal in a power saving mode and a wanted signal in a normal mode of operation; and
a receiver coupled to the signal line,
wherein the synchronization signal comprises a reduced amplitude as compared to an amplitude of the wanted signal and comprises a periodic data pattern so that the synchronization signal permits maintaining an alignment of the synchronization signal and a reference signal in the receiver.
